(19) United States
(12) Patent Application Publication
(10) Pub. No.: US 2005/0146899 A1
(43) Pub. Date: Jul. 7, 2005

(54) ELECTRICAL LIGHTING SYSTEMS

(75) Inventors: Mark Joseph, Aspen, CO (US); Jansen Simpson, Aspen, CO (US)

Correspondence Address: GLENN L. WEBB, P.O BOX 951, CONIFER, CO, 80433, US

(73) Assignee: LITESNOW LLC, Aspen, CO (US)

(21) Appl. No.: 10/905,220

(22) Filed: Dec. 22, 2004

Related U.S. Application Data
(63) Continuation-in-part of application No. 10/378,459, filed on Mar. 3, 2003.
(63) Continuation-in-part of application No. 09/920,569, filed on Jul. 31, 2001, now Pat. No. 6,540,372.

(51) Int. Cl. F21V 21/35; F21V 21/008

(52) U.S. Cl. 362/648; 362/407; 362/408

(57) ABSTRACT

An electrical lighting system. The lighting system includes a flexible track mounted by adhesive backing strips. The system may be connected to a standard household electrical outlet, connected to an existing light fixture or hardwired into the household electrical system. The system also includes adjustable hanging fixtures and undercabinet low profile fixtures

### RELATED APPLICATIONS

This application is a continuation-in-part of application 10/378,450 filed on Mar. 30, 2003 which is a continuation-in-part of application Ser. No. 09/920,569, filed on Jul. 31, 2001, now issued as U.S. Pat. No. 6,540,372 which relates to the subject matter of provisional patent application 60/222,278 filed on Jul. 31, 2000.

### FIELD OF THE INVENTION

This invention relates to the field of track lighting systems.

### BACKGROUND OF THE INVENTION

Track lighting systems are well-known for use in interior decorating, display cases, and many other uses. Typical track lighting systems use a track having an interior channel with electrical conductors within the interior channel. Light fixtures usually include two tangs that are inserted into the track interior channel and twisted until contact is made with the electrical conductors. The tracks are normally mounted to a wall or ceiling by mounting screws or hung by a pendant.

These systems are relatively difficult to install. It is necessary to cut the tracks to length with a saw or other tools and install with mounting hardware in the appropriate location. Often, it is difficult to mount the appropriate track in the desired location. Mounting of these tracks to drywall often requires complicated mounting procedures and the use of drywall screws or other hardware components. The fixtures require two hands to install and pivot in the track channel. This can often be difficult to secure due to the height of the ceiling on which the track channel is mounted.

Another problem is that the electrical connection may not be correctly made, thus causing arcing of the electrical contacts or even dislodgement of the fixture from the track. Wiring these systems into a junction box can be complicated and dangerous. The track light systems are relatively expensive once all of the components are purchased and installed. Typically, the systems require professional installation, or at the very least, tools such as saws, shears, drills, screwdrivers, as well as other tools and mechanical aptitude.

Also, there is a lack of flexibility in wiring low voltage systems into normal household electrical systems. Often, a professional electrician is required to make the necessary connections. There is also an inability to use existing junction boxes or outlets. Many existing systems require that the lighting system be connected through a household outlet, thus requiring extensive power cords draped around a room.

Another problem with existing track lighting systems is the rigidity of the tracks used in most systems. Many of the tracks used do not allow the tracks to bend around corners without using special brackets and fixtures. Even the systems that do allow the tracks to bend only allow the tracks to bend in a lateral direction, not orthogonal to the length of the track (up and down directions). The tracks are unable to be bent to conform to surface irregularities, corners, beams, and curves.

Existing track lighting systems tend to extend downward from ceilings or outward from walls with bulky fixtures. These systems are not suitable for low ceilings, small rooms or other environments where they are obtrusive. The prior systems are relatively high profile in that they do not mount flat to the mounting surface.

Another problem with existing systems is the inability to easily adjust the height of hanging fixtures. Typically this requires rewiring of the fixture or unsightly looping of the hanging chain or other hanging mechanism.

There have been a number of attempts previously to solve these problems. However, these attempts have been largely unsuccessful. Thus, a need exists for an electrical track lighting system that is easily installed with little or no tools, relatively inexpensive, bendable around surfaces, low-profile, that requires no hardwiring of electrical connections, that can be simply plugged into an outlet and having instantly installable light fixtures.

### SUMMARY OF THE INVENTION

The present invention solves these problems and others by providing a bendable track lighting system. The track lighting system of one preferred embodiment is quickly and easily installed with little or no tools or mechanical aptitude. The track lighting system can be used in almost any location and environment and can be decorated to fit unobtrusively in most decors.

In a preferred embodiment, the track lighting system includes fixtures that are quickly and securely installed on the track. The fixtures can be quickly adjusted to a desired location. In this embodiment, the fixtures can be simply snapped into place and/or removed with only one hand.

In a preferred embodiment, the track lighting system uses low-voltage current for safe and efficient use. The transformer and dimmer are low profile and can be mounted virtually anywhere. These components can be plugged into an outlet or ceiling fixture for easy use.

The track lighting system of one preferred embodiment may be hard-wired into the electrical system of the household. The system provides components to isolate the AC and low voltage connections.

The track lighting system of a preferred embodiment uses adhesive backing for use with a bendable, extruded plastic track. The track already has adhesive mounted to the surface contact side protected by a release liner. In one embodiment, the track is supplied in rolls and strips are cut to desired lengths. The track can be bent as necessary to conform to corners, beams and irregular surfaces. The flat, smooth surface of the track is very close to the mounting surface so to be unobtrusive as well as painted if desired. Thus, the track is hidden very easily and blends into the environment of the mounting surface. The track thus tends to be low profile against a ceiling or wall.

The fixtures, in one preferred embodiment, include spring clip members. These spring clip members securely attach the fixture to the track by engaging the upper side of the track. Contact surfaces on the spring clip members engage conductors on the upper surface of the track to provide current to the light fixture.

In a preferred embodiment, the base of the fixture is molded of a resilient bendable plastic material. The bendable plastic material provides spring pressure to push the spring clips against the contact surfaces by applying pressure on the opposite side of the base.

In another preferred embodiment, the track system includes adjustable hanging fixtures that can be easily and quickly adjusted in length without rewiring the fixtures.

In another preferred embodiment, the system includes light fixtures that include piercing connector members for piercing the insulation of the power tape to connect to the insulated connection elements within the power tape.

These and other features will be evident from the drawings and the detailed description of preferred embodiments.

### BRIEF DESCRIPTION OF THE DRAWINGS

FIG. 1 shows a preferred embodiment of the electrical track system of the present invention.

FIG. 2 shows a perspective view of the track of the embodiment of FIG. 1.

FIG. 3 shows a cross-sectional view of the track of FIG. 1 as well as a preferred embodiment of the light fixture of the present invention.

FIG. 4 shows a perspective view of the power tape of a preferred embodiment.

FIG. 5 shows a perspective view of a connection clip of the preferred embodiment of FIG. 1.

FIG. 6 shows a perspective view of an adaptor for a recessed light outlet of a preferred embodiment.

FIG. 7 shows another view of the embodiment of FIG. 6.

FIG. 8 shows a perspective view of the embodiment of FIG. 6.

FIG. 9 shows a front view of another preferred embodiment of a track lighting system.

FIG. 10 shows another preferred embodiment of a power supply connection.

FIG. 11 shows another view of the embodiment of FIG. 10.

FIG. 12 shows another view of the embodiment of FIG. 10.

FIG. 13 shows another view of the embodiment of FIG. 10.

FIG. 14 shows a preferred embodiment of the light fixture.

FIG. 15 shows another preferred embodiment of an adjustable hanging light fixture.

FIG. 16 shows the base unit of the embodiment of FIG. 12.

FIG. 17 is a perspective view of the embodiment of FIG. 15.

FIG. 18 show several of the light fixtures of the embodiment of FIG. 12.

FIGS. 19-23 illustrate another preferred embodiment of the present invention.

FIGS. 24-26 illustrate another preferred embodiment of the present invention.

FIGS. 27-32 illustrate another preferred embodiment of the present invention.

FIG. 33 illustrates another preferred embodiment of the present invention.

### DESCRIPTION OF PREFERRED EMBODIMENTS

The present invention provides different embodiments of electrical track lighting systems and components for electrical track lighting systems. It is to be expressly understood that the descriptive embodiments set forth herein are intended for explanatory purposes and is not intended to unduly limit the scope of the claimed inventions. Other embodiments and applications not described herein are considered to be within the scope of the invention. It is also to be expressly understood that while specific embodiments for the components of the electrical track lighting systems are discussed, other equivalents to these embodiments that perform substantially similar functions are within the scope of the claimed inventions.

Preferred Lighting System

The present invention relates to the subject matter of U.S. patent application Ser. No. 10/378,450 filed on Mar. 30, 2003 and Ser. No. 09/920,569, filed on Jul. 31, 2001, now issued as U.S. Pat. No. 6,540,372, the subject matter of both are incorporated herein by reference.

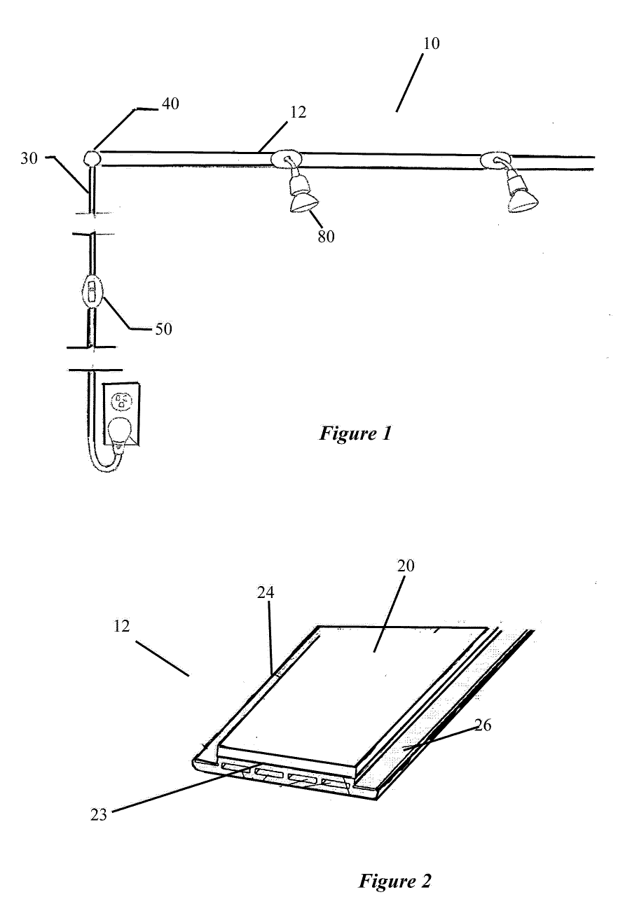

Several preferred embodiments of the present invention are illustrated in FIGS. 1-22. The electrical track lighting system 10 of a preferred embodiment shown in FIG. 1 includes a bendable track 12 having an adhesive backing, connection clips 40, a power supply 50, and fixtures 80. The system 10 is low profile, that is, the track mounts very close to the mounting surface so not to be obtrusive. The system of the exemplary preferred embodiment as described in FIGS. 1-5 is easily mounted with little or no tools other than household scissors or other common household cutting devices. This system can be bent in an up or down manner so to be mounted around corners, beams, and other irregular and/or uneven surfaces.

This bendable track 12 is formed of an extruded plastic, magnetic materials or other lightweight bendable strip material. In the preferred embodiment of FIG. 2 the bendable track 12 is formed of extruded hollow plastic material, such as polyvinyl chloride. The track 12 shown in FIG. 2 includes hollow portions 120 that act as a torsion box. This allows the track to be easily cut with household scissors due to its thin wall profile yet it can be bent by hand. This provides a bendable, yet structurally stiff, lightweight strip material that can be easily bent into position yet has no memory and will retain the bent position. It is structurally strong for mounting to walls, ceilings and other surfaces for securely holding light fixtures. The load from the fixtures is spread by a stiff track over a wide area of mounting tape. It has a thickness of 0.25 inches or less in the preferred embodiment to form a low profile structure with a flat smooth front exposed surface.

It is to be expressly understood that other materials and thickness can be used as well. The bottom exposed surface 14 of track 12 is a substantially flat planar surface. As discussed in further detail below, the smooth flat bottom surface 14 can have decorative tape mounted to it, or even painted as desired. The ability to paint the smooth flat bottom surface 14 of the track 12 as well as the low profile of the track allows it to be easily hidden from sight or else used as an accent for the room.

An adhesive strip 20, as shown in FIG. 2 is affixed onto the track 12 on the upper side 16 of the track 12 between the track and the mounting surface. The adhesive strip 20, in this particular embodiment, is formulated of a particularly aggressive adhesive that can support the track 12 on any surface. In other preferred embodiments, the adhesive may be of a less aggressive nature in order to allow easy removal for temporary use. Prior to installation, the adhesive strip includes a protective layer 22, such as a silicon-coated paper that prevents the adhesive from adhering to unintended surfaces until the track 12 is ready to install.

In a preferred embodiment, adhesive strip 20 is integrated directly into the track 12, while in the exemplary preferred embodiment, the adhesive strip 20 is mounted onto the upper side 16 of track 12. In another embodiment, the adhesive strip includes a double-sided adhesive strip covered by a protective layer. The track 12 is cut to the appropriate length for use, then the adhesive strip is applied to the track and to the ceiling or wall location.

This adhesive strip 20 is preferably attached to a foam material 23 having a thickness of about 0.1 inches, although other dimensions can be utilized as well with an adhesive layer. The foam material 23 allows the secure fastening and use of the track 12 on uneven surfaces. The foam conforms to uneven surfaces and increases the bonding with the mounting surface by increasing the adhesive surface area contact. The adhesive strip 20 can also be integrally formed as part of the track 12.

Electrical contact rails 24, 26 are mounted or formed on the upper side 16 of track 12. In the embodiment shown in FIG. 2, the contact rails are mounted to the track 12 snapping or pressing into a formed slot. The contact rails may also be mounted to the track by a thin adhesive layer or even formed as an adhesive sided tape. The contact rails 24, 26 are formed of conductive materials, such as copper, brass, aluminum or other known conductive materials. The contact rails 24, 26 are parallel and spaced from one another as well. The rails are electrically insulated from one another through the insulation properties of the track 12. The contact rails 24, 26, in the preferred embodiment, are flat copper, but could also be round, square or other shapes and sizes of exposed electrical wire as well. The contact rails extend the full length of the track 12. The flat copper rails of the preferred embodiment not only provide a low profile structure but also enable the use of common household scissors to cut the track to length. The flat copper rails is easier to cut than the same gauge of round electrical wire used in most tracks systems. In one preferred embodiment, multiple contact rails may be used with two, three, four or more contact rails to provide controlled power to deliver to various rails.

The adhesive strip 20 along with the bendable track 12 enables the lighting system to be easily installed onto almost any surface, contour, ridge, corner, wall, etc. The combination of the track, foam, and adhesive strip is bendable and can be easily bent as needed.

Electrical current is supplied to the contact rails 24, 26 of the track 12 by power tape 30. A preferred embodiment of the low profile power tape 30, as shown in FIG. 4, is connected between the transformer 50 and the track 12. The power tape 30 carries flattened electrical leads 30, 32, and is low profile with upper radiused corners. The bottom surface of the power tape is hollow and includes an adhesive backing tape 34. These features provide a low profile, unobtrusive power tape that can be painted to match the wall, ceiling or other mounting surface.

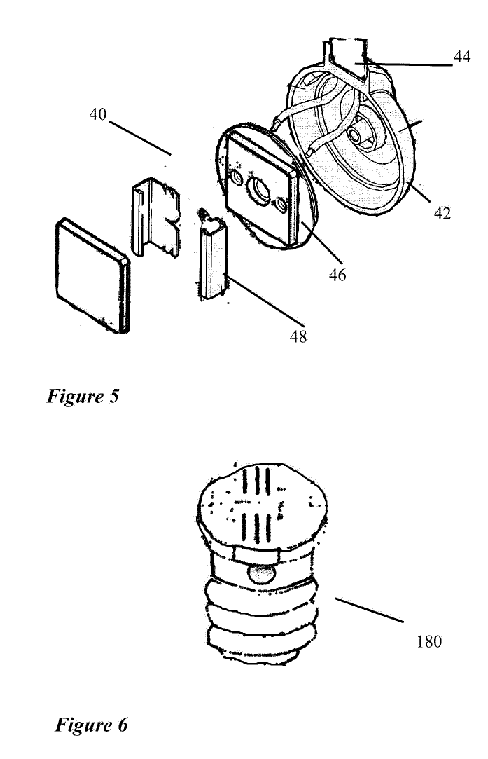

The power tape 30 is connected to the contact rails 24, 26 of the track by a connection clip 40. The connection clip 40 can also be used for connecting the tracks to the power tape at any angle to one another. Connection clip 40, as shown in FIG. 5 includes a pivotable housing. The housing 42 is able to rotate about base plate 46. The pivotable housing enables the power tape to swivel to any angle to improve the ease of mounting the track lighting system. The top 42 pops off the housing 40. The power tape 30 is cut to length and inserted into the housing through slot 44. The connection clip contacts 48 that are mounted on the base plate 46. Thus, the power tape can be connected to the contact clips 48 regardless of the angle of the power tape to the housing. The contact clips engage onto the contact rails 24, 26 of the track at any spot on the tape.

It is to be expressly understood that other mechanisms for engaging the contact leads with contact rails 24, 26 are also contemplated, such as by direct attachment through soldering; by clips, by piercing and other mechanisms. The connection mechanism may also include a pivot point to allow the tracks to be angled or bent.

In the preferred embodiment, an electrical power transformer and switch is plugged into an AC electrical outlet or wired directly into the household AC current. The AC current is transformed by electrical transformer 54 in the power supply/switch 50 into low voltage current. This current is then applied to the contact rails 24, 26. The switch 50 also includes a dimmer switch to adjust the brightness of the light fixtures as well as turn the fixtures on and off. In this embodiment, power switch 50 includes an adhesive backing to allow it to be attached to a convenient location on a wall.

The power switch includes connection wedges to allow a user to simply cut the line in cord and/or the power tape to length and insert through slots in the back plate of the power switch. The wedges are pressed inward until the contacts pierce the insulation to form an electrical connection. Other quick connection mechanisms may be used as well to attach the line in cord to the power switch.

Thus, in the preferred embodiment of the present invention, the track 12 can be easily installed by mounting the adhesive backing strip 20 on the track to the desired surface. The power tape 30 is easily connected to the track 12 to ensure electrical contact between the power tape 30 and the contract rails 24, 26. The power tape can be cut to the desired length and mounted by an adhesive backing tape 34 to the surface. The ends of the power tape are connected to a transformer or dimmer transformer to supply power to the track 12. Fixtures 80, discussed below, are mounted at desired locations along the track 12.

Electrical Track System Connected to Recessed Ceiling Can

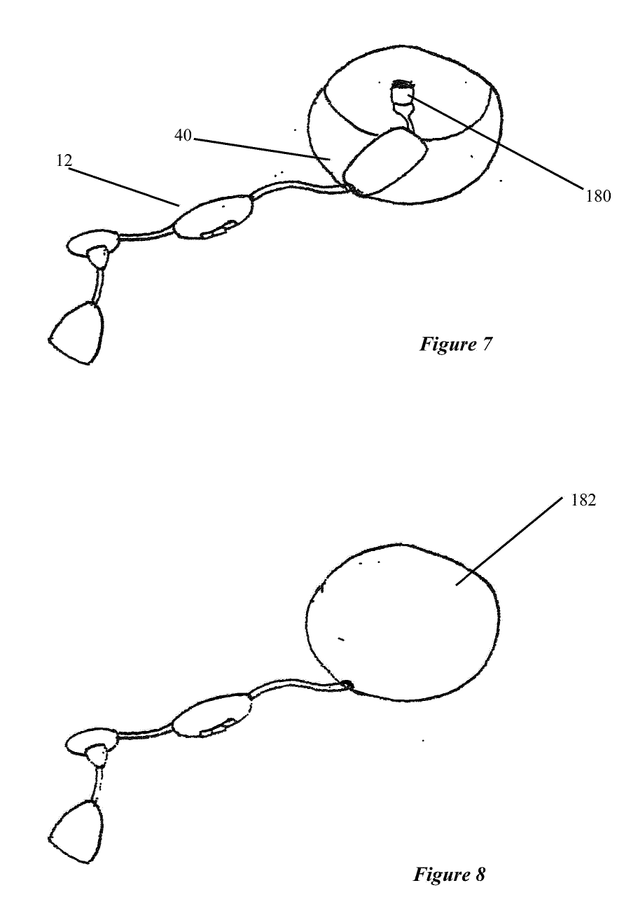

In another preferred embodiment, shown in FIGS. 6-8, the track lighting system includes an adaptor for enabling the system to be connected to an existing lighting system. As shown in FIGS. 7 and 8, the system includes track 12, connection clip 44, fixture 46, and fixtures 50. An adaptor 180, shown in FIG. 6, is also included that connects into an existing electrical light outlet, including ceiling outlets, ceiling can outlets, wall outlets, wall sconces and any other standard incandescent light outlet. A cover 182 is also included as well. The cover, in a preferred embodiment, has hook and loop tabs with adhesive backing to hold the cover in place as well as to allow quick access to adjust or service the dimmer.

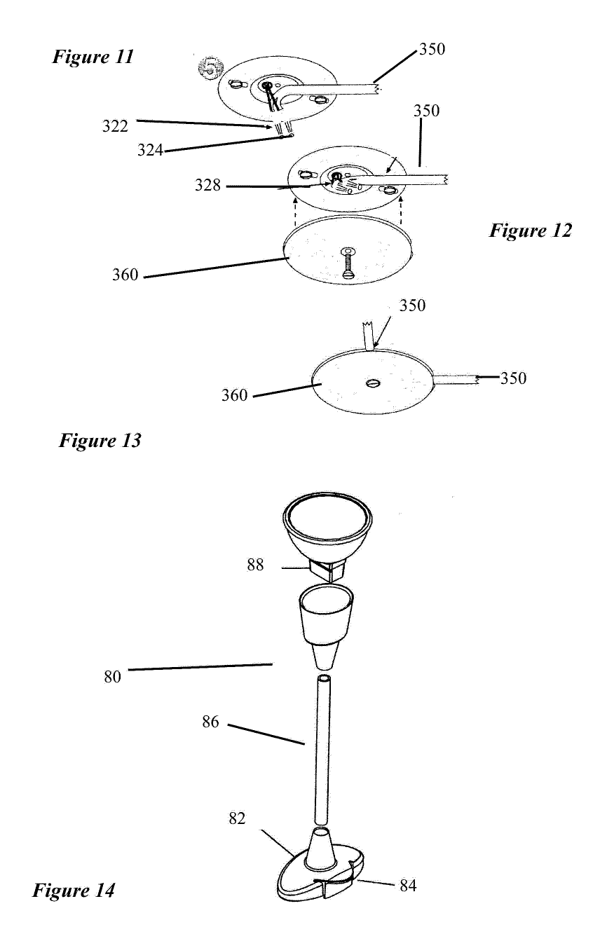

In use, the adaptor is screwed into the light outlet, such as in a recessed ceiling can type outlet. The power tape is connected to the adaptor along with the transformer. The cover 182 covers these components, as shown in FIG. 11. The cover can be painted to match the ceiling color so not be easily visible. The track, connection clip and fixtures are secured as in the other disclosed embodiments.

Accent Lighting System

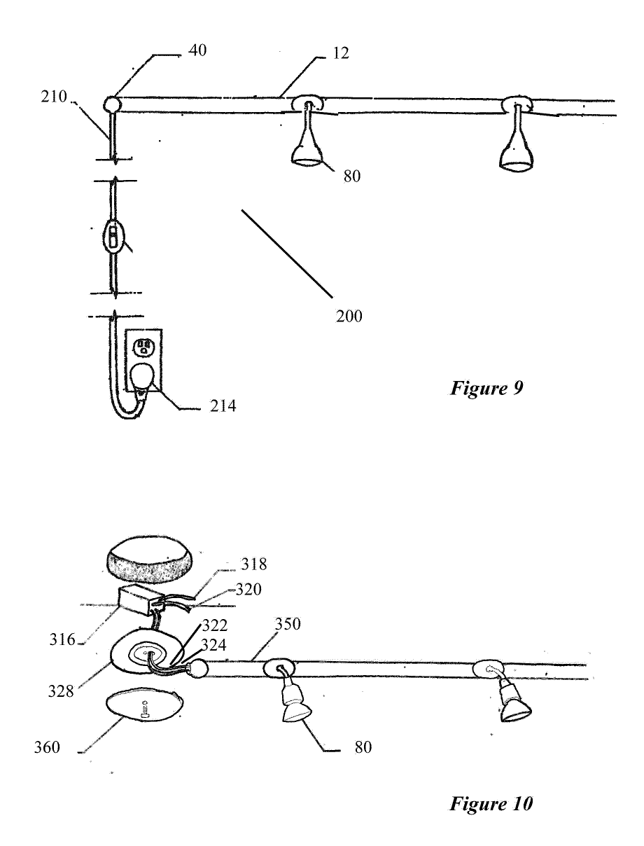

Another preferred embodiment is illustrated in FIG. 9. This system 200 includes a track 12, as described above, and fixtures 50, as described below. The system in this preferred embodiment does not utilize the power tape as described in the above embodiments. Instead, a power cord 210 with adhesive tabs 212, or in another preferred embodiment, nail-on fasteners are utilized. The power cord 210 attaches to the track 12 by the connection clip 40, described above. An electrical transformer 214 is integrated directly into the power cord 210 to transform 120 AC to low voltage current. The transformer 214 plugs directly into a standard household outlet. There is no dimmer in this embodiment. The power cord 210 runs from the transformer 214 to the connection clip 40 that is mounted to the track 12.

This embodiment has particular utility for work spaces, behind beds, shops attics, laundry rooms or other uses where there is no need for a dimmer or where aesthetics are less important. Also, this embodiment may be used for task lighting, in work cubicles, shelves, cabinets or even in trade show booths. A rotary or other in-line switch can be installed to turn the system on or off.

Hardwired Electrical Track Lighting System

In another preferred embodiment, the track lighting system 300 may be hardwired into the electrical system. This embodiment is illustrated in FIGS. 10-13. A standard junction box 310 is recessed in the mounting surface of the track lighting system, either newly installed or from an existing lighting system. Primary 120V AC electrical wires 312, 314 extend into junction box 310. Transformer 316 is mounted in the junction box 310. The transformer 316 may be held by double sided adhesive tape, electrical ties or any other mounting technique. The transformer box 316 includes primary input wires 318, 320 that receive 120V AC current and output feed wires 322, 324 that output the transformed low voltage current. The primary input wires 318, 320 are connected to the primary 120V AC wires 312, 214 and connected with wire nuts or other approved electrical connections. The output low voltage wires are fed through hole 326 in inner plate 328. The inner plate 328 is then secured against the junction box 310 by screws 330, 332 extending through holes 334, 336 in the inner plate and into threaded holes 338, 340 of the junction box to seal the junction box 310.

Electrical power tape 350, similar to the power tape 30 discussed above, includes a connection clip 352, similar to connection clip 40 discussed above. The connection clip 352 is secured to the end of the power tape 350 and connected to the track 12, as discussed in the earlier embodiment. The power tape 350 is secured by the adhesive backing to the mounting surface. The power tape 350 is cut to the appropriate length by scissors, knife or other common household utensil. The conductor wires 354, 356 in the power tape are stripped bare at the end near the junction box 310. These bare ends are connected to the output transformer wires 322, 324 by wire nuts or other approved connection methods.

Outer cover 360 is mounted to the inner plate 328 by screw 362 over the connected wires 354, 356 and 322, 324 respectively. Notches 364 are formed in the inner surface of the outer cover 360 to align over the power tape 350. Once the outer cover 360 has been mounted to cover the wires and the inner plate 328, the track lighting system is ready for use.

Additional tracks can be powered from the same power source within the junction box 310. The only limitation is whether additional transformers can be fitted in the junction box above the inner plate 328.

The present system ensures that the connections between the 120V AC supply line and the input transformer lines are separated from the connections between the low voltage output transformer line and the power tape lines. This unique connection system meets most standard codes for electrical systems. It also provides an easy method to install and connect the power tape to the transformer leads.

Light Fixtures

The exemplary preferred embodiment of the light fixture is shown in FIG. 14. Light fixture 80 includes a base member 82 formed of a high strength resilient plastic material. Clip 84 is formed on one side of the base member. A bendable tube 86, formed of a braided metal material, plastic, or other bendable material extends from the base member 82 to a lamp holder 508. A lamp socket having elongated wires extend through the bendable tube 86 for engagement with contacts that then engage with the contact rails of the track 12. Assembly wires 90 may also be used to provide structural integrity for the tube 86 to hold the lamp fixture together. In use, the user simply engages one side of the base member over the track 12 and snaps the other side over the other side of the track. The clip 84 may be used to ensure engagement or to release the lamp fixture from the track 12.

In this preferred embodiment, the base member 82 of the light fixture is formed of a molded resilient flexible plastic material. This material provides a spring pressure to push the spring clips against the contact surfaces by applying pressure on the opposite of the base member. It is also to be understood that the base member could be a stiff, rigid material and the spring clips themselves provide the resilient force.

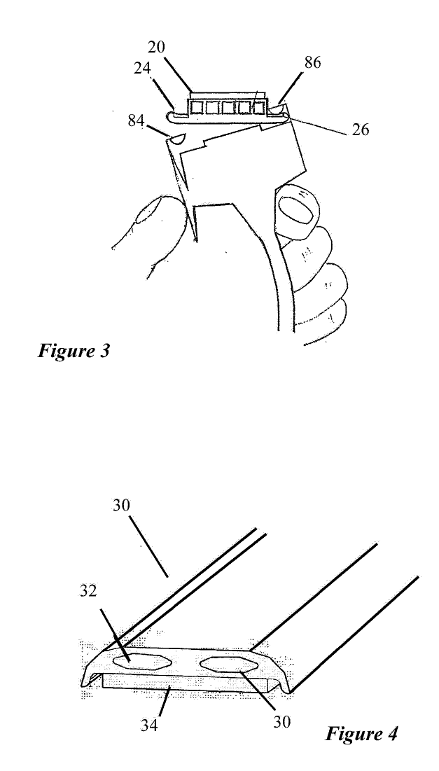

In use, the base member is grasped between thumb and finger. The clip 84 is engaged over contact rail 24 as shown in FIG. 3 as the fixture is pivoted until clip 84 engages over contact rail 26. The fixture is easily removed from the track by engaging the base member to pull the resilient clip 84 away from the contact rail 24. This releases the fixture from the track.

Adjustable Hanging Light Fixture

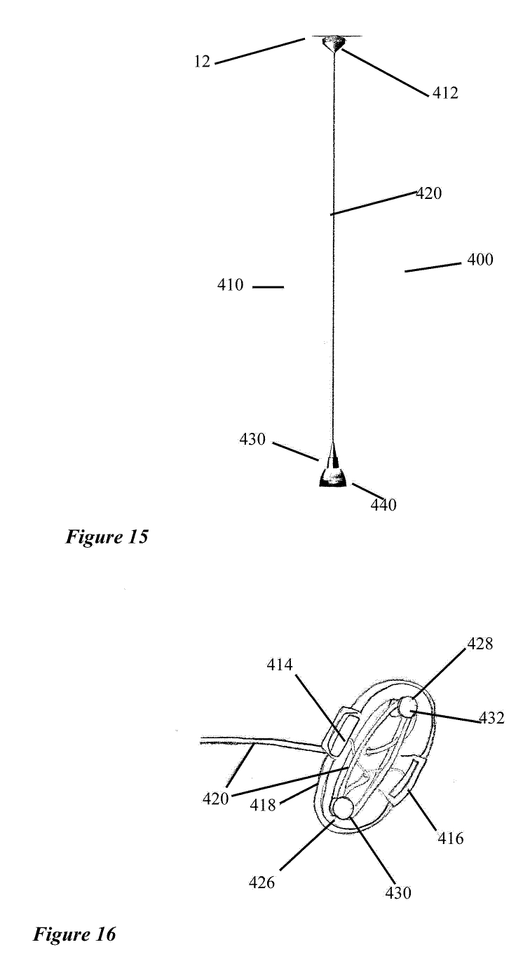

In a preferred alternative embodiment, lighting system 400 includes an adjustable hanging light fixture 410, as shown in FIGS. 15-18. The lighting system 400 includes for descriptive purposes the track lighting system discussed in the earlier embodiments. This track lighting system includes a track 12 having opposing contact rails 24, 26, power tape 30, connection clip 40 and a transformer 54. It is to be expressly understood that other types of track lighting systems or even stand-alone lighting can be used as well with the fixture of this preferred embodiment.

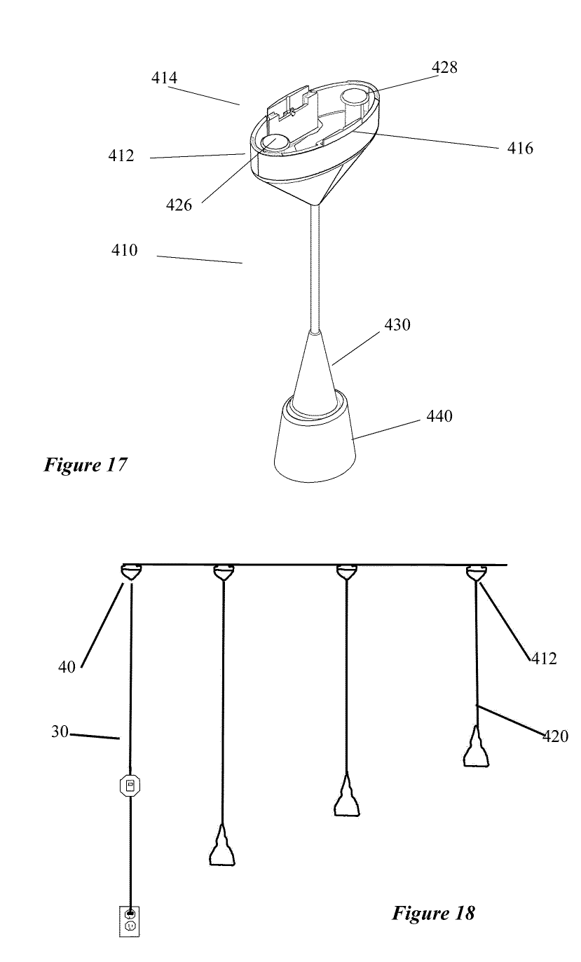

Adjustable hanging light fixture 410 includes a base unit 412, electrical power cord 420, lamp socket 430 and lamp 440. The base unit 412, as shown in FIG. 17, includes opposing connection clips 414, 416 mounted on the upper surface of the base unit and extending above the mounting surface 418 of the base unit 412. In this preferred embodiment, at least one of the connection clips 414, 416 is resiliently biased to allow the base unit to mount onto the track under spring force. A hole 420 is formed in the lower surface of the base unit 412. Power cord 420 extends through hole 420 and connects to the connection clips 414, 416. In this preferred embodiment, the power cord includes an inner insulated power feed line 422 and a metal braided outer covering that acts as a second power feed line 424 covering the inner power feed line. It is to be expressly understood that two insulated power feed lines may also be used as well or two insulated power feed lines within an insulated covering.

Posts 426, 428 extend upwards within the housing of the base unit 412 on opposite ends of the base unit 412. Expanded heads 430, 432 are formed on upper ends of posts 426, 428 and will be discussed in greater detail below.

Power cord 420 extends away from the base unit 412 and terminates in connection with the lamp socket 430. The lamp socket 430 is of standard design and includes connection mechanism for connecting to the power feed lines 422, 424 of the power cord 420. Lamp bulb 440 is mounted to the lamp socket 430 to receive power from the power cord 420. A shade 442 may also surround the lamp bulb to dissipate the light as desired.

In use, the base unit 412 is connected to the track 12 as described in the earlier light fixture embodiment. The power cord 420 extends downward and supports the lamp socket 430.

In the preferred embodiment of the present invention of the adjustable hanging fixture 410, the length of the power cord 420 may be adjusted without having to disconnect or reconnect the feed lines 422, 424. The base unit 412 is simply removed from the track 12. The power cord 420 is pushed upward into the base unit 412. The power cord 420 is wrapped around the posts 426, 428 as shown in FIG. 14 to reduce the length of the power cord 420 between the base unit 412 and the lamp socket 430. The expanded heads 430, 432 on the posts 426, 428 keep the power cord from slipping downward and also prevent the connection clips 414, 416 from coming into contact with the power cord 420 wrapped about the posts as shown in FIG. 20. In the preferred embodiment, the hanging light fixture 410 may be easily adjusted between eight feet to one feet, although any adjustment length may be performed depending on the thickness of the power cord and the room within the base unit 412.

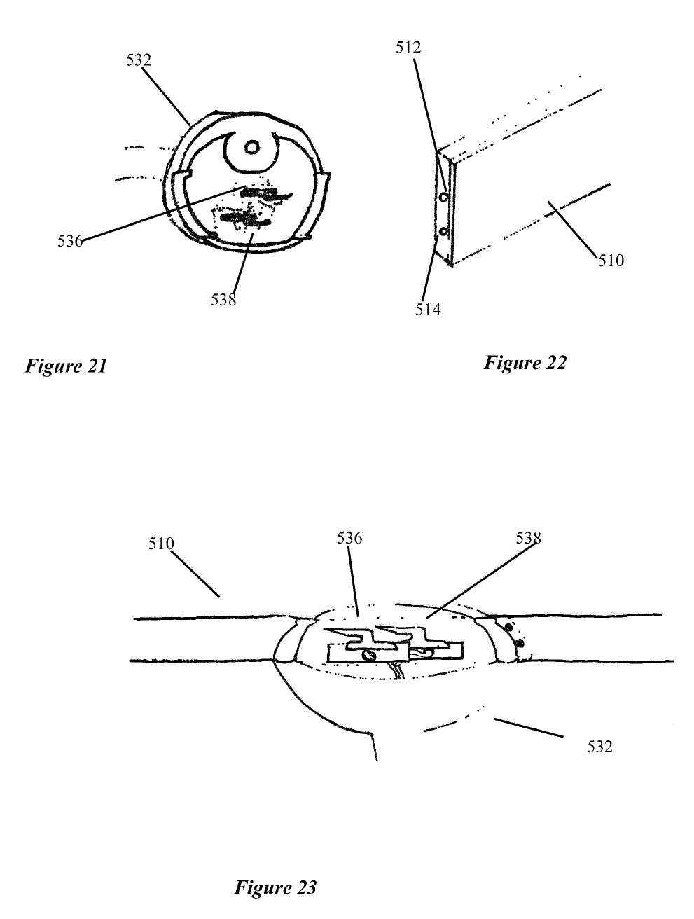

The present invention, in this preferred embodiment, thus allows the length of a hanging fixture to be quickly and easily adjusted to a desired height as shown in FIG. 21. It is to be expressly understood that while the above description uses the track and power system of the earlier embodiments, this embodiment also may be used with other track systems or stand alone hanging light systems.

Installation

In the preferred embodiment, the lighting strip 10 is supplied in rolls. In a preferred embodiment, the track 12 is provided in a compact package wrapped around the fixtures and other components as opposed in elongated boxes of the prior track systems. The appropriate length of the strip 10 is unrolled and cut to length with shears, scissors, or other commonly used utensils. The person installing the light strip simply removes the protective layer 22 from the adhesive strip 20, and the upper side of the track 12 is firmly pressed in the desired location. The entire lighting system can be installed with only the use of common household scissors or other common household cutting devices.

The use of the adhesive strip 20 provides full support along the entire length of the strips 12. This ensures that there will not be stress points along the strip 10, and there is no need to attempt to locate studs, rafters or other support members in the surface for attachment. Also, there is no need to drill and/or install anchors in the surface. The bendable property of the strips allow them to be installed over complex surfaces, around corners, even wrapped around vertical and horizontal beams and other surfaces including uneven surfaces. These systems can not only be used in household areas, but in commercial areas, trade shows and with the appropriate precautions, outdoors. These systems can be permanently installed or used as temporary lighting as well. There is no need for professional installation as these systems can be installed with little mechanical aptitude or even any tools.

The torsion box design of the track spreads the load of the fixtures over a wide area of the track and the adhesive strip. This provides a secure system that is also lightweight and low profile. The torsion box design also allows the track to be bent up and down while providing lateral integrity.

The preferred embodiment of the lighting strip of the present invention uses the adhesive strip as described. It is to be expressly understood that other mechanisms for attachment can be used as well, such as mechanical fasteners in high stress areas.

The bottom side 14 of the track 12 can either be painted to match the surface on which it is applied, or to provide accent to that surface. In a preferred embodiment, covers are supplied to prevent the contact rails 24, 26 from being painted. These covers can be quickly removed after the strip surfaces are painted to minimize fouling of the contact surfaces by paint. Also, decorative tape can be provided to mount onto the bottom side in the appropriate color or pattern as well. The low profile flat section of the track renders it essentially invisible when painted to match the surface upon which it is mounted. The clip and power tape may also be painted as well.

The connection clip can then be mounted on the track 12 as shown in FIG. 6. Multiple connection clips 34 may be used in order to connect different tracks to one another if desired. For example, it may be desired to install different strips at angles to one another, or to connect long runs of the strips together. Connection clips include contact members that engage the contact rails 24, 26 of the different strips 12 to one another in the appropriate polarity.

Light fixtures 80 can be quickly installed by hand at any desired location along the track 12. The fixtures 80 are mounted by grasping the spring clip members, engaging a first spring clip member onto a contact surface and pivoting the fixture until both spring clip members engage the contact surfaces. Current then can flow from the contact surfaces of the track through the clip members to the light bulb 54.

It is to be expressly understood that other engagement mechanisms can be used as well as well as different combinations of the spring contact clip members, spring clips and magnetic members.

In another preferred embodiment, the track lighting system includes an adaptor that engages in an existing incandescent light outlet and a cover. The adaptor is inserted into the existing light outlet, such as in a recessed ceiling outlet. The power tape is inserted into the adaptor and the adaptor and transformer are hidden within the recessed can. The cover is placed over the recessed can and painted to match the ceiling. The backing strip, connection members and light fixtures are mounted to the adjacent ceiling. The existing electrical controls then control the operation of the light fixtures.

Piercing Light System

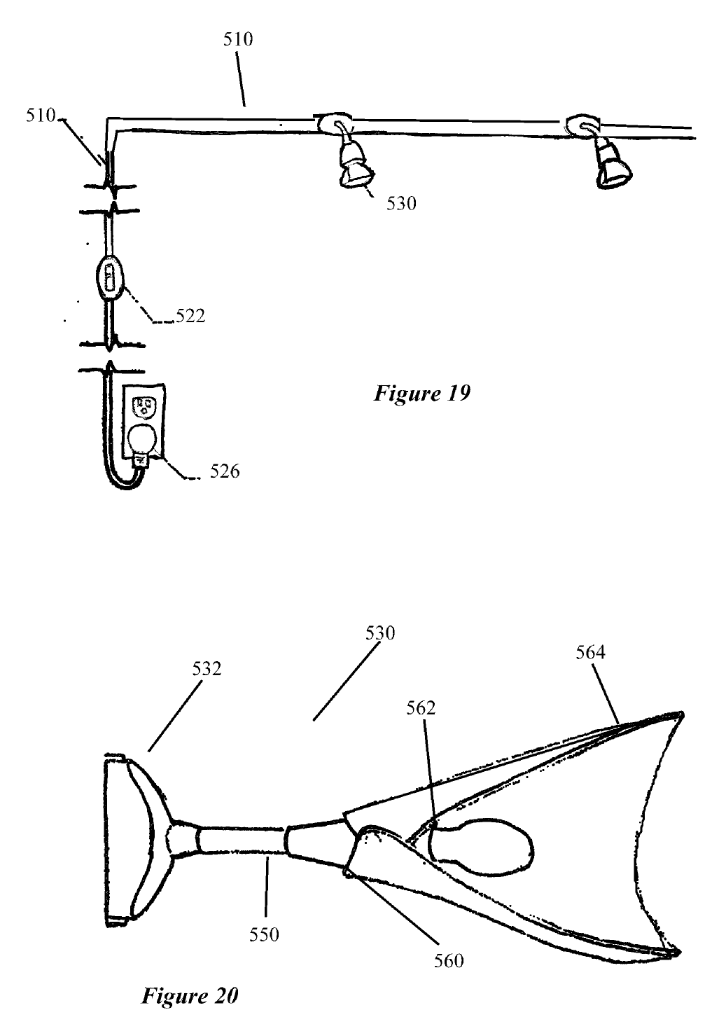

Another preferred embodiment of a track lighting system is illustrated in FIGS. 19-23. This track lighting system may be mounted on most surfaces and is easily mounted. The track lighting system 500 includes a power tape 510, similar to power tape 30 described above. The power tape 30 includes parallel connection wires 512, 514 mounted within an insulated housing 516. An adhesive backing strip 520 is secured to mounting surface 518 of the power tape 510.

The power tape 510 is connected to a transformer 522. The transformer is capable of transforming 120V AC power to low voltage current. In this preferred embodiment, a dimmer switch 524 is operably connected to the transformer. A power cord 526 connects the transformer to a standard household outlet.

The power tape 510 is mounted to a surface, such as a wall, ceiling, office cubicle or other locations such as for task or accent lighting by attaching the adhesive backing strip to that surface. The power tape is flexible and is able to bend to almost any angle and over almost any surface or obstacle. The transformer 524 and dimmer switch are also attachable by adhesive backing strips so to be located at a convenient location.

The fixture 530 of this preferred embodiment includes a base unit 532, a flexible shaft 550 and a lamp holder 560. The base unit 532 includes a unique mounting mechanism 534. The mounting mechanism 534 includes conductive sharp nosed piercing members 536, 538. The piercing members 536, 538, as shown in FIG. 23 include a needle portion 540, 542, respectively extending perpendicular to the length of the fixture 530 and parallel to the conductive wires 512, 514 of the power tape 510. The piercing members 536, 538 are connecting to power feed lines 540, 542 that extend from the base unit 532 through the flexible shaft 550 and connect to lamp holder 560. Recesses 544, 546 are formed in the upper surface of the base unit 512 and shaped to allow power tape 530 to fit partially therein.

The lamp holder 560 is a standard design and connects the power feed lines 540, 542 to lamp socket 562 for receiving and powering a lamp bulb, such as a halogen or incandescent light bulb. Lamp shade 564 is also mountable to the lamp holder to diffuse light from the light bulb.

In use, the base unit 532 is secured to the power tape 510 by angling the base unit 532 against the power tape 510 to align the piercing members 536, 538 with the conductive wires 512, 514 of the power tape 510. Pressure is then applied to cause the piercing members to penetrate the insulation of the power tape and make conductive contact with the conductive wires. The piercing members pierce into the initial insulation, penetrate the conductive wires but does not pass through the insulation on the opposing sides. The perpendicular angle of the piercing members hold the fixture to power tape 510. In other preferred embodiments, additional securing mechanism may be used, such as push pins or securing screws to provide additional security.

The light fixtures 530 may be mounted anywhere along the power tape 510 as desired. The flexible shaft of the light fixture and lamp shade 564 allow adjustment of the light from the light fixture to provide the best utilization of the light fixtures. In a preferred embodiment, the shade has a hinge to open and close around the light fixtures.

Plug In Transformer

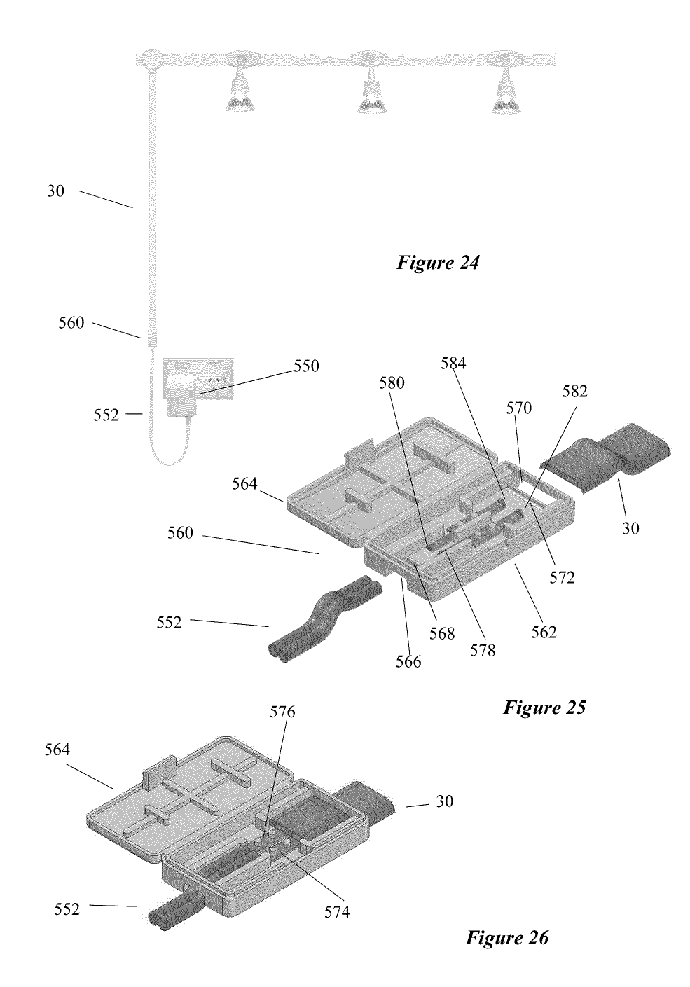

Another preferred embodiment is illustrated in FIGS. 24-26. This embodiment is similar to the above described embodiments except the transformer is built into the plug that connects into the electrical outlet. As shown in FIG. 24, the transformer 550 is plugged directly into the wall electrical outlet. A lamp cord 552 is connected from the transformer 550 by connector 560 to power tape 30 described above. The connector 560, as shown in FIGS. 24 and 25, includes a housing 562 with cover 564, lamp cord inlet 566, locking ridge 568, power cord inlet 570, locking ridge 572 and connectors 574, 576 having piercing points 578, 580, 582, 584. The lamp cord is inserted through inlet 566 and over locking ridge 568 and piercing points 578, 580. The power tape is inserted through inlet 570 and over locking ridge 572 and piercing points 582, 584. The cover 564 is closed which forces the piercing points to connect the lamp cord and the power tape together. The locking ridges then prevent the lamp cord and power tape from inadvertently being pulled from the connector 560.

Under Cabinet Lighting System

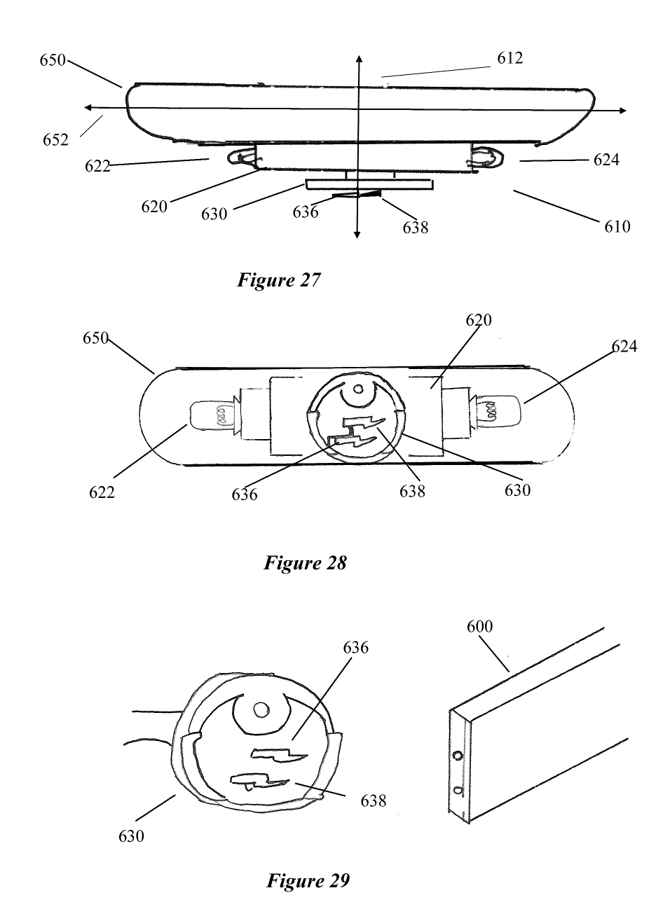

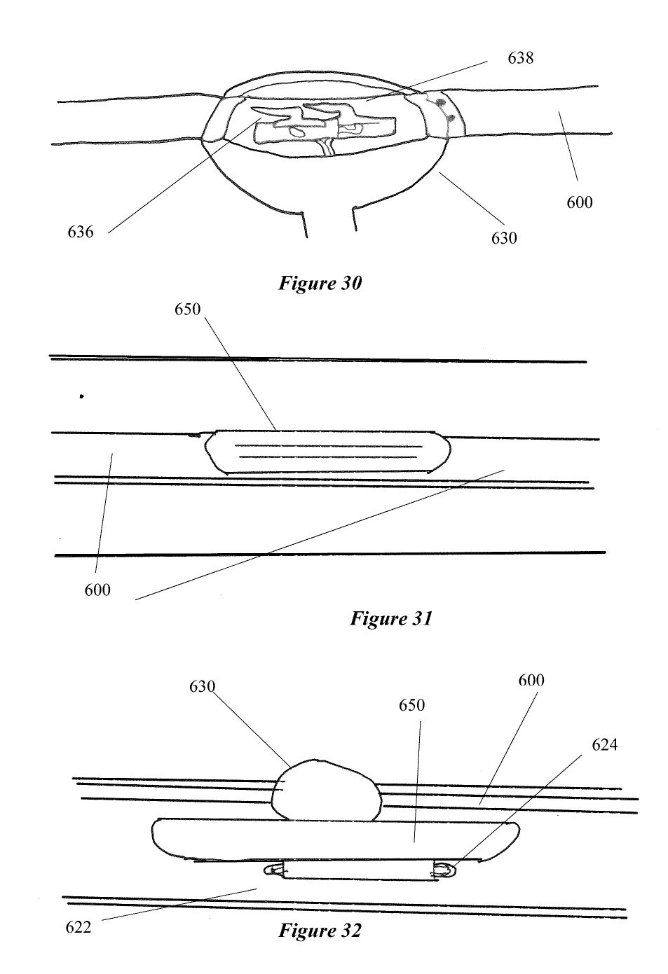

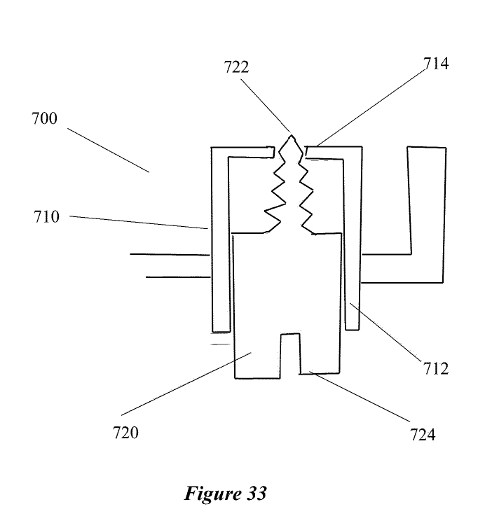

Another preferred embodiment is illustrated in FIGS. 27-33. This preferred embodiment is particularly useful for under cabinet lighting, display lighting and task lighting. It is to be expressly understood that these descriptive uses are not intended to limit the scope of the claimed invention. The lighting system of this preferred embodiment includes an adhesive backed power tape 600 having at least two conductive elements extending through it, as described in the embodiments of the power tape above. The power tape is connected to a transformer, switch and power cord as described above as well.

This embodiment includes lamp fixture 610. The lamp fixture 610 includes a base unit 620. Base unit 620 includes dual lamp holders 622, 624 aligned along an axis to one another. Lamp bulbs 624, 626 are mounted by conventional mechanisms in the respective lamp holders 622, 624. The base unit 620 is mounted to swivel on mounting base 630 in direction perpendicular to the axis of the dual lamp holders.

Mounting base 630 includes conductive sharp nosed piercing members 636, 638. The piercing members 636, 638, as shown in FIG. 23 include a needle portion 640, 642, respectively extending perpendicular to the length of the fixture 610 and parallel to the conductive wires of the power tape 600. The piercing members 636, 638 are connecting to power feed lines that extend from the mounting base to the lamp holders 622, 624.

An elongated shroud 650 is mounted to extend beyond the perimeters of the lamp bulbs 624, 626 mounted in the dual lamp holders 622, 624. The shroud is mounted relative to the base unit 620 to swivel about the base unit 620 about the axis of the dual lamp holders.

In use, the power tape is cut and mounted to the underside of a cabinet, display case, or any other surface, particularly where accent lighting is desired. The lamp fixture 610 is secured to the power tape by angling the mounting base 630 against the power tape to align the piercing members 636, 638 with the conductive wires of the power tape. Pressure is then applied to cause the piercing members to penetrate the insulation of the power tape and make conductive contact with the conductive wires. The piercing members pierce into the initial insulation, penetrate the conductive wires but does not pass through the insulation on the opposing sides. The perpendicular angle of the piercing members hold the fixture to power tape. In other preferred embodiments, additional securing mechanism may be used, such as push pins or securing screws to provide additional security.

Also, other mounting mechanisms may be used as well such as the clip members of the above-described embodiments, magnetic attachments, and any other mechanism for securing the light fixtures to the power tape.

Once the light fixture 610 has been securely attached to the power tape in the desired location, the base unit 620 may be swiveled relative to the mounting base 630 to orient the lamp bulbs in a desired manner. Then the shroud may be swiveled to cause direct or reflected light from the lamp bulbs to create the desired effect. This enables accent lighting to be created in a quick and easy manner without complicated mounting mechanisms.

Another feature that improves the secure attachment of the lamp mounting fixture is to secure the mounting base 630 with a screw attachment to the mounting location, particularly in an under cabinet mounting. A preferred embodiment of the present invention provides a unique mounting assembly that enables the secure and accurate mounting even in blind locations such as the under side of a cabinet. The mounting assembly 700, shown in FIGS. 27-28 include a plastic mounting fixture 710 formed with cylindrical aperture 712 and pilot hole 714. Mounting screw 720 closely fits within cylindrical aperture 712 so that it is perfectly aligned. Needle tip 722 on mounting screw is inserted through pilot hole 714. Screwdriver engagement slots 724 (straight or Phillips) allows the user to engage the mounting screw 720 and drive it to engage the screw into the mounting surface. The alignment of the mounting screw within the cylindrical aperture 712 assures that the screw and mounting fixture are perfectly aligned and rigidly held in place while screwed with a screw driver. The length of the threaded portion of the screw 720 is limited to assure that the screw will not penetrate the opposing surface of the mounting location. This system eliminates the need to drill pilot holes, and to attempt to align the screw in awkward positions.

It is to be expressly understood that the above described embodiments are provided for explanatory purposes and do not limit the claimed inventions to only these features, either alone or in different combinations.

1. An electrical track lighting system wherein said system comprises:
a non-conductive track having an adhesive mounting surface;
a first contact surface on said track;
a second contact surface on said track spaced from and parallel to said first contact surface;
an electrical supply for supplying electrical power to said first contact surface and said second contact surface;
a light fixture;
a first contact surface affixed to said light fixture;
a second contact surface affixed to said light fixture; and
an attachment mechanism for attaching said light fixture to said track so that said first contact surface on said track engages said first contact surface on said light fixture and said second contact surface on said track engages said second contact of said light fixture.

2. The electrical track lighting system of claim 1 wherein said electrical supply includes:
a transformer for converting AC voltage to low voltage; and
an adaptor for connecting said transformer to an existing light fixture for receiving AC voltage.

3. The electrical track lighting system of claim 1 wherein said electrical supply includes:
an AC power source;
a transformer for connecting AC current to low voltage current;
input power feed lines from said AC power source connected to said transformer;
output low voltage power feed lines from said transformer connected to said track; and
a plate separating said connection between said input power feed lines and said transformer and said connection between said output low voltage power feed lines and said track.

4. The electrical lighting system of claim 1 wherein said electrical power supply includes:
a power tape having a low profile;
adhesive mounting strip for securing said power tape to a mounting surface;
a connection clip connecting said power tape to said track;
a transformer for converting AC current to current; and
a connection mechanism for connecting said power tape to said transformer.

5. The electrical track lighting system of claim 1 wherein said electrical power supply includes:
a power cord;
a connection clip connecting said power tape to said track; and
a transformer for converting AC current to current;
a connection mechanism for connecting said power cord to said transformer; and
a connection mechanism for connecting said power cord to an AC power source.

6. The electrical track lighting system of claim 1 wherein said electrical supply includes:
a power cord;
a connection clip connecting said power tape to said track; and
a transformer for converting AC current to current;
a connection mechanism for connecting said power cord to said transformer;
a connection mechanism for connecting said power cord to an AC power source;
a power tape having a low profile;
a connection clip connecting said power tape to said track; and
a connection mechanism for connecting said power tape to said transformer.

7. The electrical track lighting system of claim 1 wherein said track includes:
a flexible power cord;
conductive elements within said flexible power cord and surrounded by insulation; and
piercing connectors on said light fixture for penetrating said insulation and connecting to said conductive elements for providing power to said light fixture.

8. The electrical track lighting system of claim 1 wherein said light fixture includes:
an adjustable hanging light fixture.

9. The electrical track lighting system of claim 1 wherein said light fixture includes:
a hanging light fixture;
a base unit on said hanging light fixture;
a lamp holder;
a flexible member extending between said base unit and said lamp holder; and
at least one post within said base unit for wrapping said flexible member around said at least one post to adjust the length of said flexible member.

10. The electrical track lighting system of claim 1 wherein said electrical supply includes:
a transformer for supplying the electrical power, said transformer plugs directly into an electrical outlet; and
a power cord connecting from said transformer; and
a connector for connecting from said power cord to said first contact surface and said second contact surface.

11. An electrical track lighting system wherein said system comprises:
a non-conductive track having an adhesive mounting surface;
two conductive elements on said track;
an electrical supply for supplying electrical power to said conductive elements;
a transformer for converting AC voltage to low voltage;
an adaptor for connecting said transformer to an existing light fixture for receiving AC voltage;
a light fixture;
a first contact surface affixed to said light fixture;
a second contact surface affixed to said light fixture; and
an attachment mechanism for attaching said light fixture to said track so that said first contact surface on said track engages said first contact surface on said light fixture and said second contact surface on said track engages said second contact of said light fixture.

12. The electrical track lighting system of claim 11 wherein said electrical supply includes:
an AC power source instead of said existing light fixture;
said adaptor includes an electrical connection mechanism, said electrical connection mechanism includes:
a transformer for connecting AC current to low voltage current;
input power feed lines from said AC power source connected to said transformer;
output low voltage power feed lines from said transformer connected to said track; and
a plate separating said connection between said input power feed lines and said transformer and said connection between said output low voltage power feed lines and said track.

13. The electrical lighting system of claim 11 wherein said electrical power supply includes:
a power tape having a low profile;
adhesive mounting strip for securing said power tape to a mounting surface;
a connection clip connecting said power tape to said track;
a transformer for converting AC current to current; and
a connection mechanism for connecting said power tape to said transformer.

14. The electrical track lighting system of claim 11 wherein said track includes:
a flexible power cord;
conductive elements within said flexible power cord and surrounded by insulation; and
piercing connectors on said light fixture for penetrating said insulation and connecting to said conductive elements for providing power to said light fixture.

15. The electrical track lighting system of claim 11 wherein said light fixture includes:
an adjustable hanging light fixture.

16. The electrical track lighting system of claim 11 wherein said light fixture includes:
a hanging light fixture;
a base unit on said hanging light fixture;
a lamp holder;
a flexible member extending between said base unit and said lamp holder; and
at least one post within said base unit for wrapping said flexible member around said at least one post to adjust the length of said flexible member.

17. An electrical track lighting system wherein said system comprises:
a non-conductive track having an adhesive mounting surface;
two conductive elements on said track;
an electrical supply for supplying electrical power to said conductive elements;
a light fixture;
a first contact surface affixed to said light fixture;
a second contact surface affixed to said light fixture;
an attachment mechanism for attaching said light fixture to said track so that said first contact surface on said track engages said first contact surface on said light fixture and said second contact surface on said track engages said second contact of said light fixture; and
said attachment mechanism including two spaced piercing members for penetrating said track to engage said two conductive elements without passing through the opposing side of said track.

18. The electrical track lighting system of claim 17 wherein said attachment mechanism includes:
said two spaced piercing members extending parallel to said conductive elements of said track for securing said light fixture from accidental disengagement.

19. The electrical track lighting system of claim 17 wherein said electrical supply includes:
a transformer for converting AC voltage to low voltage; and
an AC power source.

20. The electrical track lighting system of claim 19 wherein said electrical supply includes:
input power feed lines from said AC power source connected to said transformer;
output low voltage power feed lines from said transformer connected to said track; and
a plate separating said connection between said input power feed lines and said transformer and said connection between said output low voltage power feed lines and said track.

21. The electrical track lighting system of claim 19 wherein said electrical supply includes:
an adaptor for connecting said transformer to an existing light fixture.

22. The electrical lighting system of claim 17 wherein said electrical power supply includes:
a power tape having a low profile;
adhesive mounting strip for securing said power tape to a mounting surface;
a connection clip connecting said power tape to said track;
a transformer for converting AC current to current; and
a connection mechanism for connecting said power tape to said transformer.

23. The electrical track lighting system of claim 17 wherein said track includes:
a flexible power cord;
conductive elements within said flexible power cord and surrounded by insulation; and
said piercing connectors on said light fixture for penetrating said insulation and connecting to said conductive elements for providing power to said light fixture.

24. The electrical track lighting system of claim 17 wherein said light fixture includes:
an adjustable hanging light fixture.

25. The electrical track lighting system of claim 17 wherein said light fixture includes:
a hanging light fixture;
a base unit on said hanging light fixture;
a lamp holder;
a flexible member extending between said base unit and said lamp holder; and
at least one post within said base unit for wrapping said flexible member around said at least one post to adjust the length of said flexible member.

26. An electrical lighting system, said electrical lighting system comprises:
an lamp base unit;
at least one lamp holder on said lamp base unit mounted to swivel about a first axis relative to said lamp base unit;
a shroud mounted on said lamp base unit to at least partially cover said at least one lamp holder and mounted to swivel about an axis perpendicular to said first axis; and
a mounting mechanism to mount said lamp base unit to an electrical power source.

27. A mounting mechanism for blind attachment of fixtures to a surface; said mounting mechanism comprising:
a mounting fixture;
a cylindrical aperture formed in said mounting fixture;
a pilot hole formed in said fixture aligned with said cylindrical aperture; and
a screw closely fitted into said cylindrical aperture so that the tip of said screw emerges through said pilot hole.

28. The mounting fixture of claim 27 wherein said fixture includes:
a screw closely fitted into said cylindrical aperture so that it is rigidly supported and aligned for easy installation with a screw driver.
